(19) United States
(12) Patent Application Publication
(10) Pub. No.: US 2019/0220753 A1
(43) Pub. Date: Jul. 18, 2019

(54) REDUCING REDUNDANCY IN DATA RULES

(71) Applicant: Target Brands, Inc., Minneapolis, MN (US)

(72) Inventors: Natarajan Ramamurthy, Bangalore (IN); Rajat Garg, Bangalore (IN); Andrew Michael Nash, Minneapolis, MN (US)

(21) Appl. No.: 15/870,076

(22) Filed: Jan. 12, 2018

(51) Int. Cl. G06N 5/02; G06F 17/30

(52) U.S. Cl. CPC G06N 5/025; G06F 17/30557; G06F 17/30303; G06F 17/30572

(57) ABSTRACT

A computer-implemented method includes receiving a request to test a proposed data rule and applying the proposed data rule to entity data to obtain a set of entities that violate the proposed data rule. Identifying a stored set of entities that is within a similarity threshold of the set of entities that violate the proposed data rule, wherein the stored set of entities contains entities that violate an existing data rule. A user interface is then generated to display the existing data rule as being similar to the proposed data rule based on the identified stored set of entities.

### BACKGROUND

One measure of the quality of data is whether the data complies with rules defined for the data. For example, if a particular manufacturer only makes children's clothing, a data entry for an article of clothing made by the manufacturer should not indicate that the article of clothing is for adults. The amount of time required for a computer to validate all data entities against all data rules is a function of the number of data compliance rules that are used by the system. In large systems where there are large amounts of data and a large number of rules to be applied to the data, ensuring that all data in the system satisfies all data compliance rules requires a large amount of computational resources.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving a request to test a proposed data rule and applying the proposed data rule to entity data to obtain a set of entities that violate the proposed data rule. Identifying a stored set of entities that is within a similarity threshold of the set of entities that violate the proposed data rule, wherein the stored set of entities contains entities that violate an existing data rule. A user interface is then generated to display the existing data rule as being similar to the proposed data rule based on the identified stored set of entities.

In accordance with a further embodiment, a computing device includes a memory and a processor. The processor executes instructions to perform steps that include receiving a proposed data rule and obtaining a list of entities that violate the proposed data rule. A level of similarity between the list of entities that violate the proposed data rule and a list of entities that violate an existing data rule is then determined and is used to determine whether to display that the existing data rule is similar to the proposed data rule.

In accordance with a still further embodiment, a method includes applying a new data rule against a subset of an entire data set to identify entities that violate the new data rule and applying an existing data rule against the subset of the entire data set to identify entities that violate the existing data rule. The entities that violate the new data rule are compared to the entities that violate the existing data rule. The new data rule is not applied to the entire data set when the entities that violate the existing data rule are sufficiently similar to the entities that violate the new data rule.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a data compliance system.

FIG. 2 is a user interface showing a data rule.

FIG. 3 is a flow diagram for generating and storing a representative entity vector for a data rule.

FIG. 4 is a flow diagram for comparing an entity vector of a proposed data rule to stored entity vectors to identify similar data rules.

FIG. 5 is an example user interface showing results of a test for similar data rules.

FIG. 6 is an example of a user interface showing a similar data rule.

FIG. 7 is a block diagram of a computing device in accordance with various embodiments.

### DETAILED DESCRIPTION

Embodiments described herein improve the functioning of a data compliance computing system by identifying existing data compliance rules (data rules, for short) that are similar to a proposed data rule before the proposed data rule is applied to all of the data in a large dataset. By identifying such similar data rules, the various embodiments reduce redundant calculations in the data compliance system by preventing similar data rules from being independently applied to the entire dataset. By preventing such redundant data rules from being applied to the entire dataset, the various embodiments increase the speed with which the full set of data rules can be applied against the entire dataset.

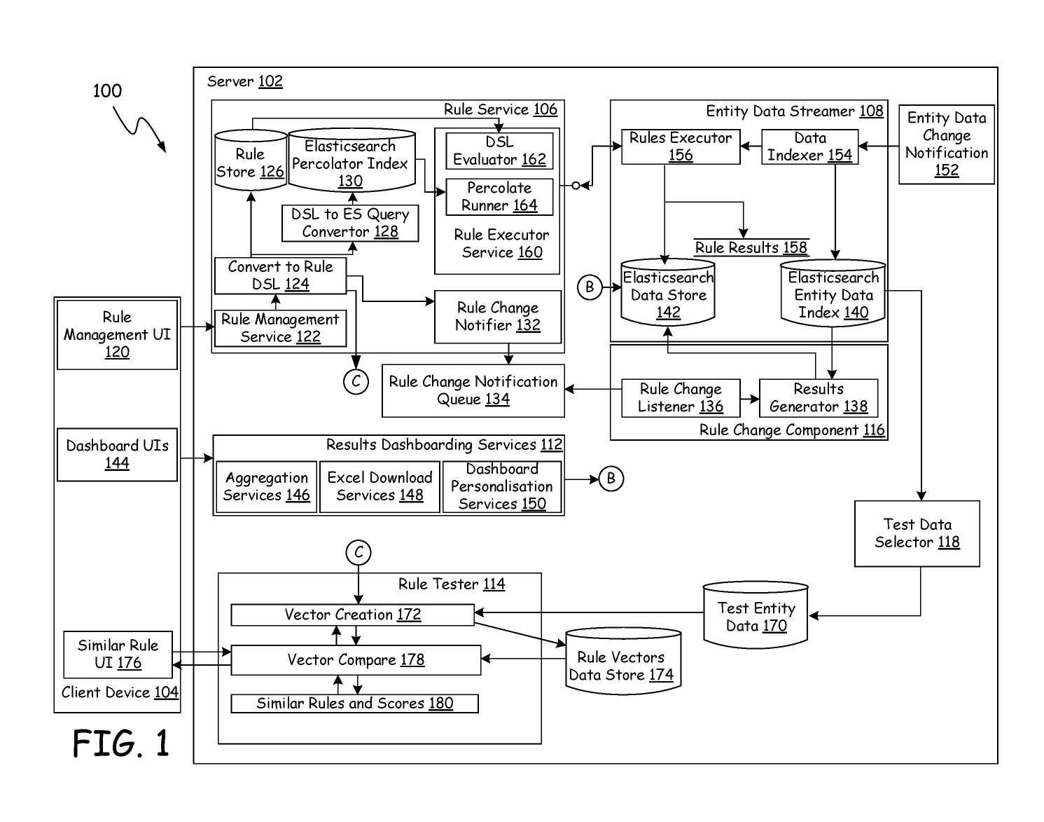

FIG. 1 provides a block diagram of data compliance system 100 running on a server 102, and accessed by client device 104. Server 102 includes a rule service 106, an entity data streamer 108, results dashboard services 112, rule tester 114, rule change component 116, and test data selector 118. Rule service 106 receives new data rules through a rule management user interface 120 on client device 104. In particular, rule management service 122 in rule service 106 receives parameters for the new data rule, which are converted to a domain specific language by DSL converter 124. The parameters for the new data rule are provided to rule tester 114, which determine if the new data rule is similar to an existing data rule as described further below. If the new data rule is not similar to an existing data rule, the domain specific language version of the data rule is stored in a rule store 126. The data rule is also converted into an elasticsearch query by converter 128 and the elasticsearch query is stored in elasticsearch percolator index 130.

When a new data rule is added or a data rule is changed, a rule change notifier 132 receives the new or changed data rule and generates a rule change notification that is placed in a rule change notification queue 134. A rule change listener 136 in rule change component 116 monitors queue 134 and removes new or changed data rules in the order they were added to queue 134. Rule change listener 136 then invokes a results generator 138, which applies the new or changed data rule to each data entity in an elasticsearch entity data index 140. Thus, the new or changed data rule is applied against every entity in the data compliance system 100 by results generator 138. In this context, a data entity is a collection of data field:value pairs for a single item in a database, where the data field:values can be distributed across multiple tables within the database. Example types of items include products, locations, people, events, services or accounts, for example. The data rules specify allowable combinations of data field:value pairs for entities in the database. In some embodiments, the data rules include logic statements that specify the type of item that the data rule applies to. Entities that violate the new or changed data rule are identified by results generator 138 and are stored in an elasticsearch result data store 142. The results can be viewed by the user using a dashboard UI 144 on client device 104, which requests the results through results dashboarding services 112 including aggregation services 146, excel download services 148 and dashboard personalization services 150.

Entity data streamer 108 updates elasticsearch entity data index 140 each time it receives an entity data change notification 152 indicating that a new data entity has been created or an existing data entity has been changed in the database. In particular, a data indexer 154 indexes the data regarding the entity and adds the indexed information to elasticsearch entity data index 140. When indexing the data, data indexer 154 treats each entity as a separate document and each data field:value pair of the entity as being found in the document. In addition, data indexer 154 provides the index data to a rules executor 156, which retrieves every data rule in rule store 126 or equivalently in elasticsearch percolator index 130 and executes the retrieved data rules against the new or changed data entity. Each data rule that the new or changed data entity violates is then identified and stored in elasticsearch results 142 and rule results 158. Rules executor 156 requests the data rules through rule executor service 160, which allows rules executor 156 to designate whether a domain specific language evaluator 162 or an elasticsearch percolator runner 164 is to be used to retrieve the data rule.

Thus, in data compliance system 100, any new data rule is applied to all existing data entities in elasticsearch entity data index 140 and any new or changed entity is applied to all existing data rules in rule store 126 or equivalently in elasticsearch percolator index 130.

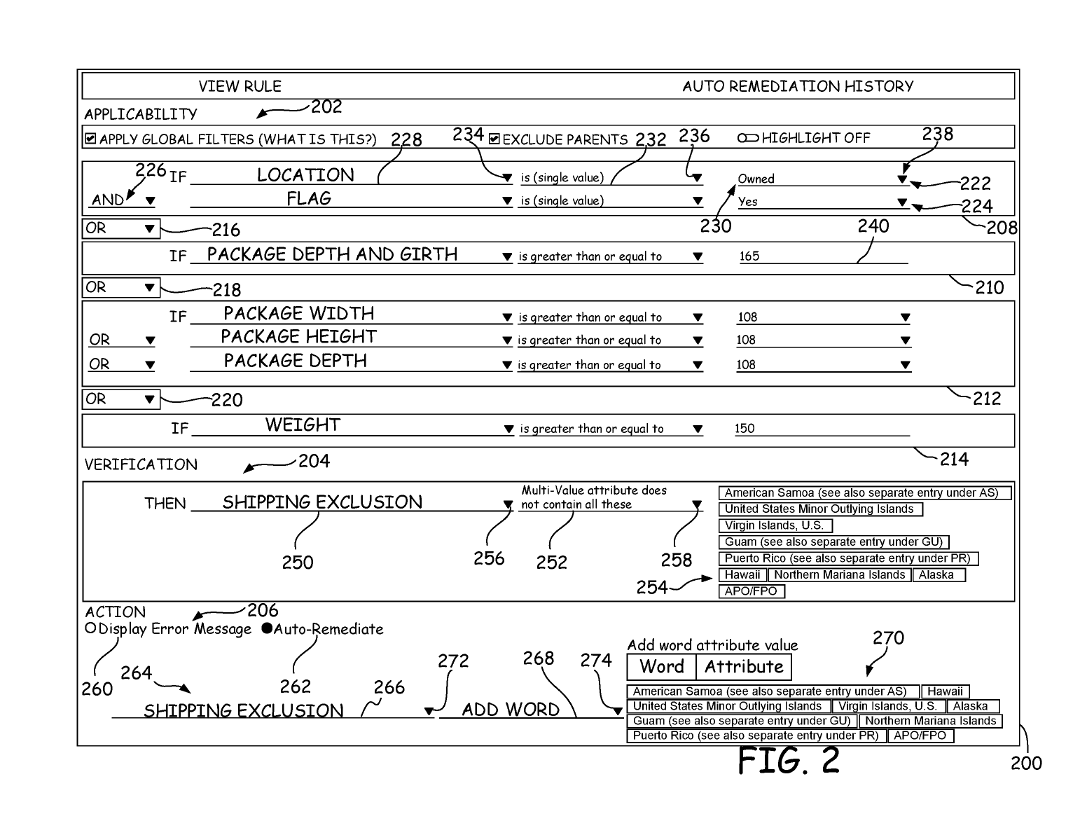

FIG. 2 provides a user interface 200 used to create a data rule in accordance with one embodiment. User interface 200 includes applicability area 202, verification area 204, and action area 206. Applicability area 202 consists of one or more “IF” statements, such as IF statements 208, 210, 212, and 214 that are combined by logical operators, such as logical operators 216, 218, and 220. Logical operators 216, 218 and 220 can include: “AND” requiring that both IF statements to be true and “OR” requiring that at least one of the IF statements be true.

Each IF statement consists of one or more logic statements that can be evaluated to a true or false value. When more than one logic statement is present, a connective is selected to form a compound statement. For example, in compound IF statement 208, logic statement 222 is connected to logic statement 224 by connective term 226. Each logic statement includes a data identifier, such as data identifier 228, a value, such as value 230, and a relationship operator, such as relationship operator 232. The statement is evaluated by retrieving the value of the data identified by data identifier 228 and determining if the retrieved value has the relationship set by relationship operator 232 to value 230. In accordance with one embodiment, possible data identifiers are stored in rule store 126 and can be accessed through a pulldown control, such as pulldown control 234. Possible relationship operators can be accessed through a pulldown control, such as pulldown control 236. For certain data entities, only a limited set of values are possible. For such data entities, a pulldown control, such as pulldown control 238 is provided to select one of the limited set of values. Other data entities may have an unlimited number of values. For such data entities, a value may be entered, such as value 240 of FIG. 2.

The statements in applicability area 202 are used to specify a combination of data elements that must be present in a data entity in order for the data entity to be evaluated. Verification area 204 provides the rule evaluation or test that is to be applied to each data entity that satisfies the compound statements of applicability area 202. The test in verification area 204 contains a data identifier, such as data identifier 250, a relationship operator, such as relationship operator 252, and a value or values, such as values 254. If the compound IF statement of applicability area 202 is found to true, then the verification statement in verification area 204 is evaluated by retrieving the values of the entity for data identifier 250 and determining whether the retrieved data values are related to the values in value area 254 in the way designated by relationship operator 252. Data identifier 250 can be selected using a pulldown control 256 that lists all available data entities as stored in rule store 126. Relationship operator 252 can likewise be selected using a pulldown control 258, which provides a list of all available relationship operators. Values 254 can be manually entered or can be retrieved from entity data 140.

When the verification statement in verification area 204 evaluates to “true”, the data entity identified in the verification statement is considered to not violate the data rule. However, when the verification statement in verification area 204 evaluates to “false”, the data entity is considered to violate the data rule and an action designated in action area 206 is taken. Examples of possible actions include sending an error message and auto remediation. Which action is taken is controlled by the selection of one of two radio buttons 260 and 262. As shown in the example of FIG. 2, when auto remediation is selected, an action is defined by an action statement 264 that will alter the entity in entity data index 140. In particular, data identified by a data identifier 266 is modified using modification instruction 268 and modification data 270. The data identifier 266 can be selected using a pulldown control 272 and the data function can be selected using a pulldown control 274. If the action selected is to display an error message using radio button 260, a text field is provided to allow the entry of the error message to be displayed.

In accordance with various embodiments, rule tester 114 in FIG. 1 identifies when a new data rule is similar to an existing data rule. Because of the large number of data identifiers and combination of data identifiers that are available, a computer system can easily miss similar rules if it searches for matching logic statements between a proposed data rule and existing data rules. Embodiments described below, improve the technology of identifying similar data rules by examining data entities that are identified as violating each data rule to determine which data rules produce similar sets of violating data entities. If two data rules produce the same set of violating data entities, the two data rules are considered to be similar to each other, even if the two data rules use different logic statements.

In large systems, there can be millions of entities in data index 140. To reduce the processing required to identify redundant data rules, a subset of entity data 140 is created and the existing data rules in rule store 126 and the new proposed data rule are applied against the subset of entity data to identify a subset of the violating entities for each data rule. The subset of violating entities for the new data rule is then compared against the respective subsets of violating entities for each existing data rule to identify all existing data rules that are similar to the new data rule based on the similarity between the subsets of violating entities.

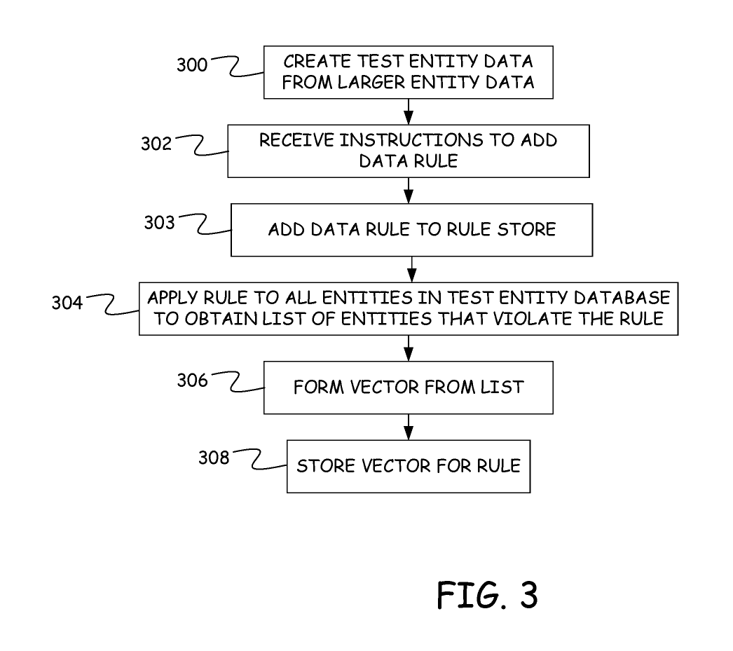

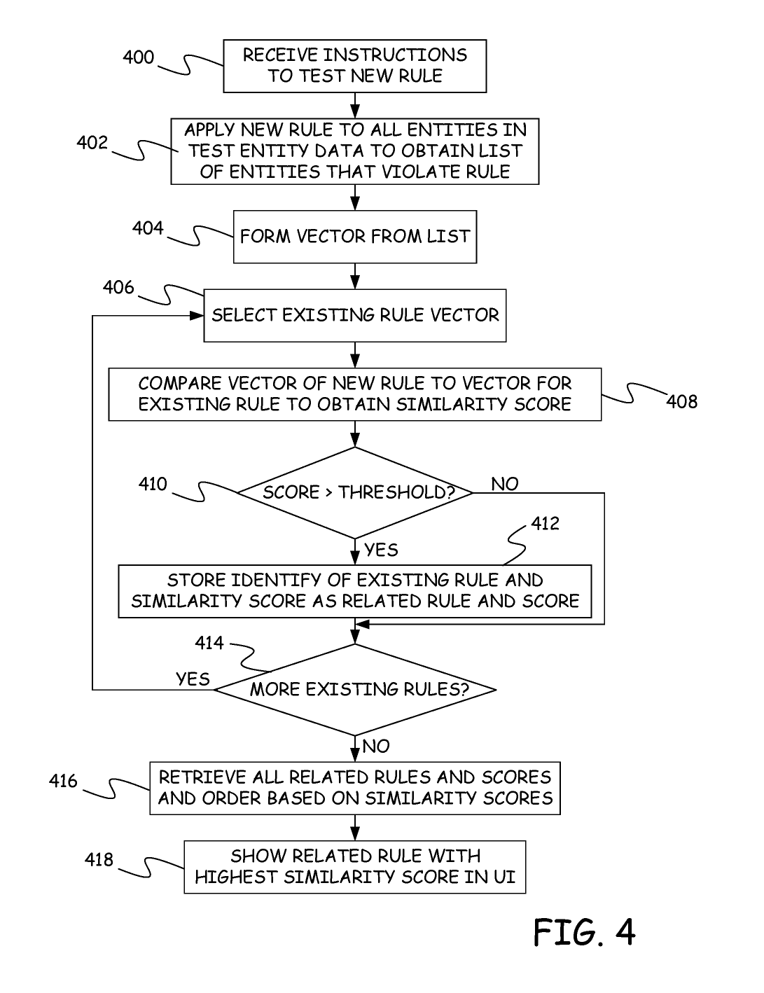

FIG. 3 provides a flow diagram of a method for forming the subsets of violating entities for data rules in rule store 126 and FIG. 4 provides a flow diagram of a method for identifying and displaying data rules that are similar to a new data rule based on the subsets of violating data entities for the new data rule and for the existing data rules in rule store 126.

In accordance with one embodiment, the method of FIG. 3 discussed below is started after entities have been placed in entity data index 140 but before any data rule has been added to rule store 126. In step 300 of FIG. 3, test entity data 170 is formed by test data selector 118 from entity data index 140. In accordance with one embodiment, test data selector 118 selects some percentage of entity data index 140 to form test entity data 170, such as 10%. In accordance with one embodiment, the data is selected randomly such that the data in test entity data 170 is representative of the data in entity data index 140.

At step 302, instructions to add a data rule to rule store 126 are received through rule management UI 120. At step 303, a domain specific language (DSL) version of the data rule is produced by DSL convertor 124 and is stored in data store 126. This DSL version of the data rule is also provided to a vector creation module 172 in rule tester 114. At step 304, vector creation module 172 applies the data rule to all entities in test entity data 170 to obtain a list or set of all entities in test entity data 170 that violate the data rule. In accordance with one embodiment, the list or set can include zero or more entities. At step 306, vector creation module 172 uses the list of entities to form a vector, which is stored at step 308 in a rule vector data store 174. In accordance with one embodiment, the vector is formed by using identifiers for each of the entities that violated the data rule. In one particular embodiment, the identifiers are ordered based on their values and then concatenated to form the vectors.

In FIG. 3, step 300 is performed once while steps 302, 304, 306, and 308 are performed each time a new data rule is added to rule store 126. In further embodiments, test entity data 170 can be reformed from time to time by repeating step 300. After test entity data 170 is reformed, each data rule in rule store 126 is applied by vector creation module 172 to the newly formed test entity data to form a new vector for the data rule. Each new vector then replaces the existing vector for the data rule in rule vector data store 174.

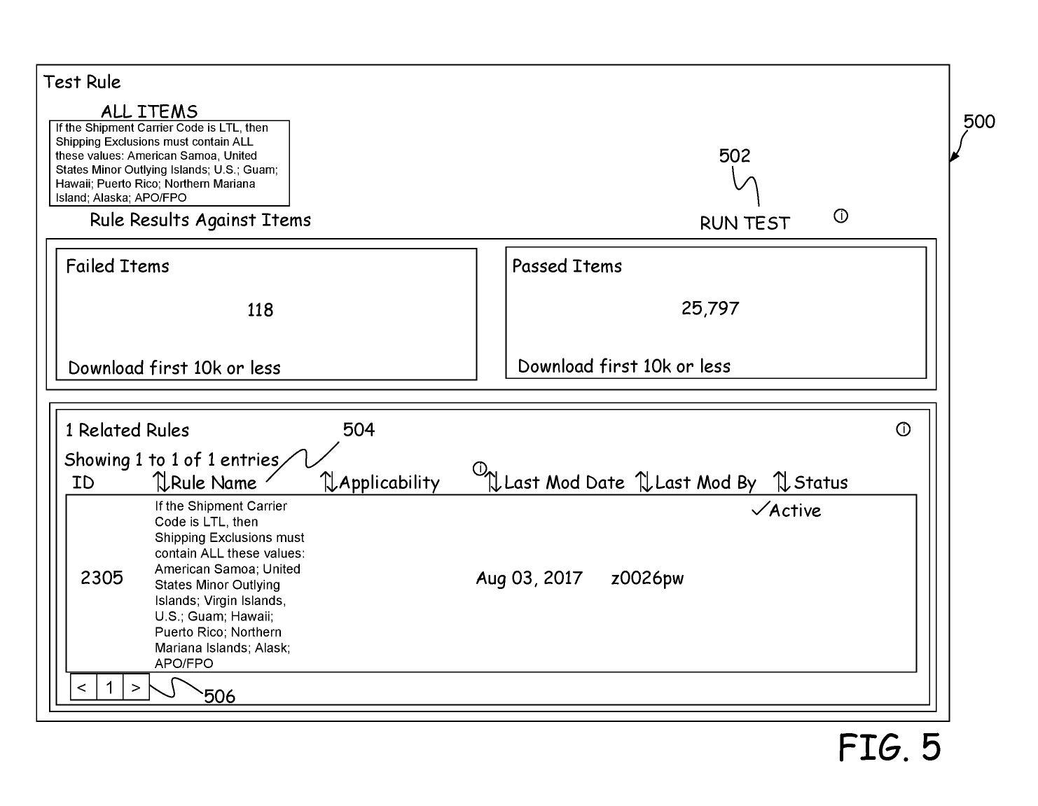

Once vectors have been created for the existing data rules in rule store 126, the vectors can be used to determine if a new data rule is similar to an existing data rule using the method of FIG. 4. In step 400 of FIG. 4, rule tester 114 receives a request to test a new data rule through a similar rule user interface 176. FIG. 5 provides a user interface 500, which is an example of similar rule user interface 176. In user interface 500, when a RUN TEST control 502 is selected, the domain specific language version of the data rule is provided to a vector compare module 178. At step 402, vector compare module 178 invokes vector creation module 172 to apply the new data rule to all entities in test entity data 170 to obtain a list or set of entities that violate the data rule. The list or set of entities can include zero or more entities. Since test entity data 170 is a subset of entity data index 140, the list of entities that violate the data rule is a subset of the entities in entity data index 140 that violate the data rule. At step 404, vector creation module 172 uses the list of violating entities to construct a vector in the same way in which the vectors in rule vector data store 174 were created.

At step 406, vector compare module 178 selects an existing data rule vector from rule vector data store 174 and compares the vector of the new data rule to the vector for the existing data rule to obtain a similarity score at step 408. The similarity score provides a level or degree of similarity between the entities violated by the new data rule and the entities violated by the existing data rule. In accordance with one embodiment, this comparison involves applying the two vectors to a function, such as a dot product function, to identify a value that is representative of the similarity between the two vectors. This value is then used as the similarity score. Although vectors are used in the embodiment described above, in other embodiments, other techniques for measuring the level or degree of similarity between the lists or sets of violating entities for the new data rule and the existing data rule can be used.

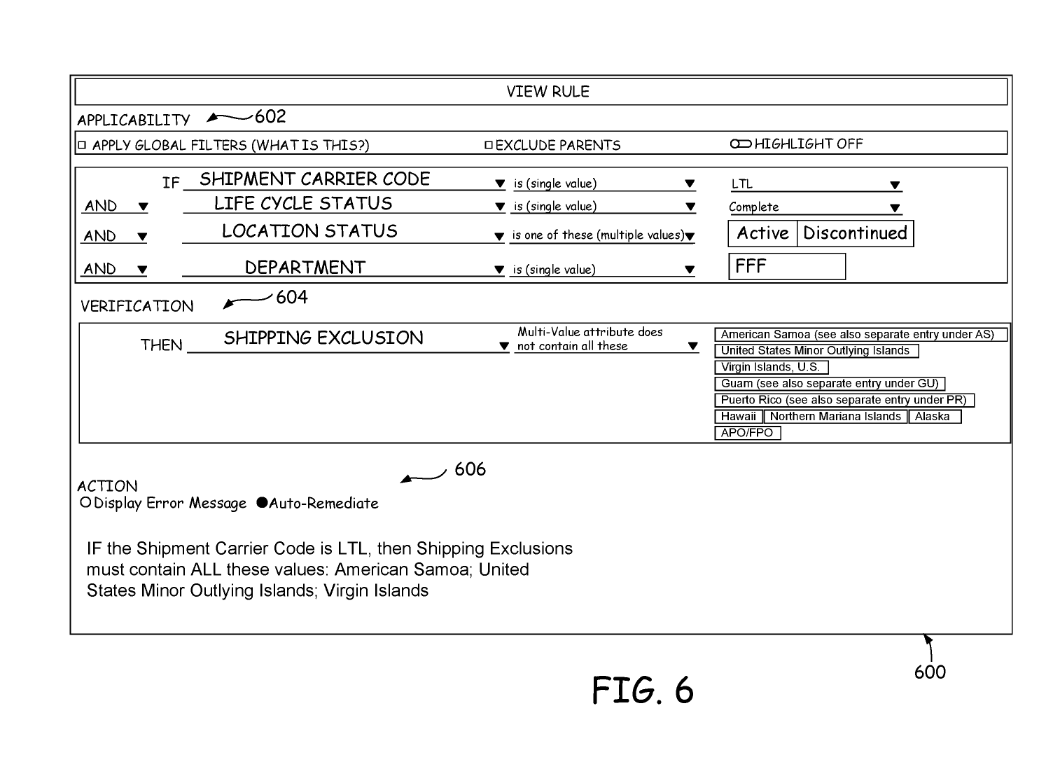

At step 410, vector compare module 178 compares the similarity score to a similarity threshold to determine if the vector of the new data rule is sufficiently similar to the vector of the existing data rule to warrant displaying that the new data rule is possibly redundant of the existing data rule. In accordance with one embodiment, two vectors are considered to be sufficiently similar if the similarity score for the two vectors exceeds the similarity threshold. If the two vectors are sufficiently similar, the identity of the existing data rule and the similarity score are stored in similar rules and scores 180 at step 412. Note that because the entities are being compared instead of the content of the data rules themselves, in some embodiments, the new data rule will be identified as possibly being redundant of an existing data rule even though the new data rule has at least one criterion different from the existing data rule. For example, the different criterion can include an additional logical statement, a missing logical statement, a different operator to combine logic statements or different values within logical statements. If the similarity score is not greater than the threshold at step 410 or after step 412, vector compare module 178 continues at step 414 where it determines if there are more existing data rule vectors in rule vector data store 174. If there are more data rule vectors, vector compare module 178 returns to step 406 to select the next existing data rule vector and steps 408, 410 and 412 are repeated for the newly selected existing data rule vector. When there are no more existing data rule vectors at step 414, the process continues at step 416 where vector compare module 178 retrieves all similar rules and scores and orders them based on the similarity scores. At step 418, vector compare module 178 generates or updates user interface 176 to show the similar rule with the highest similarity score. For example, in FIG. 5, user interface 500 has been updated to show similar rule 504 having ID 2305. User interface 500 also includes a control 506 that can be used to display the other similar rules with a similarity score that exceeded the threshold. Thus, a plurality of existing data rules can be displayed as being similar to the new data rule when the respective data entities that violate each of the existing data rules are sufficiently similar to the data entities that violate the new data rule. By selecting one of the similar data rules, details for the similar data rule can be shown in a separate window shown in window 600 in FIG. 6. In window 600, the applicability statements 602, the verification statements 604 and the action 606 of the similar data rule can be viewed in detail.

Upon viewing the similar data rule, the user can decide not to add the new data rule to rule store 126 and instead use the similar data rule identified in accordance with the various embodiments. This improves the operation of the computing device because the new data rule does not need to be run against every data entity in entity database 140. Further, by using the vectors of entities that violate the data rules instead of the logic statements in the data rules themselves, embodiments improve the technological process of identifying similar data rules by finding data rules that have the same outputs as each other even though their logic statements may be different form each other. As a result, the various embodiments do not have to generate possible alternatives to the logic statement of the new data rule to identify similar data rules that are similar to the proposed new data rule. This greatly reduces the number of computations that must be performed and simplifies the identification of similar data rules.

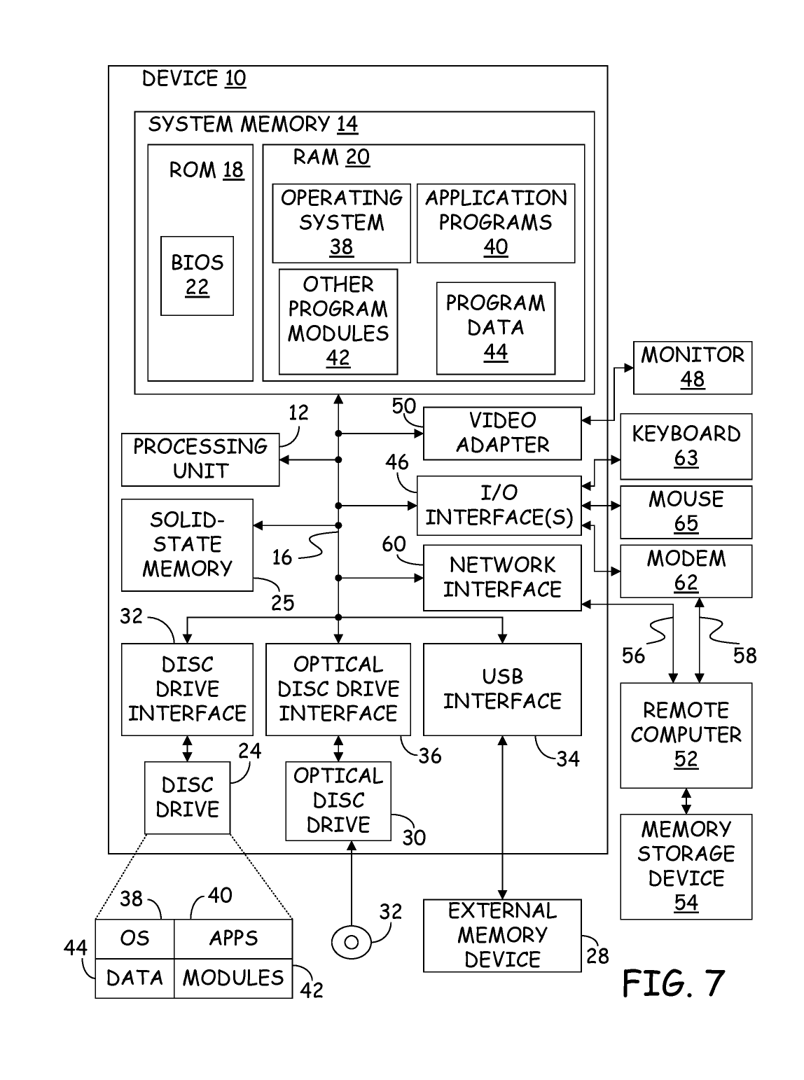

FIG. 7 provides an example of a computing device 10 that can be used as server 102 or client device 104 in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of vector creation 172, vector compare 178, similar rule UI 176, test data selector 118, rule service 106, rule change component 116, entity data streamer 108, results dashboarding services 112, rule management user interface 120 and dashboard user interface 144, for example. Program data 44 may include data such as entity data index 140, rule store 126, test entity data 170, vector data store 174, and similar rules and scores 180, for example.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 7. The network connections depicted in FIG. 7 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 7 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving a request to test a proposed data rule;
applying the proposed data rule to entity data to obtain a set of entities that violate the proposed data rule;
identifying a stored set of entities that is within a similarity threshold of the set of entities that violate the proposed data rule, wherein the stored set of entities contains entities that violate an existing data rule; and
generating a user interface to display the existing data rule as being similar to the proposed data rule based on the identified stored set of entities.

2. The computer-implemented method of claim 1 wherein the entity data is a subset of entity data in a system.

3. The computer-implemented method of claim 2 further comprising identifying a plurality of stored sets of entities that are each within the similarity threshold of the set of entities that violate the proposed data rule, each stored set in the plurality of stored sets containing entities that violate a respective existing data rule.

4. The computer-implemented method of claim 3 further comprising generating the user interface to display each of the respective existing data rules as being similar to the proposed data rule.

5. The computer-implemented method of claim 4 further comprising ordering each of the respective data rules based on a level of similarity between the respective stored sets of entities and the set of entities that violate the proposed data rule.

6. The computer-implemented method of claim 1 wherein identifying a stored set of entities that is within a threshold similarity of the set of entities that violate the proposed data rule comprises:
applying a vector representation of the stored set of entities and a vector representation of the set of entities that violate the proposed data rule to a function to generate a similarity score and comparing the similarity score to a threshold similarity score.

7. The computer-implemented method of claim 1 wherein the existing data rule has at least one criterion that differs from the proposed data rule.

8. A computing device comprising:
a memory; and
a processor, executing instructions to perform steps comprising:
receiving a proposed data rule;
obtaining a list of entities that violate the proposed data rule;
determining a level of similarity between the list of entities that violate the proposed data rule and a list of entities that violate an existing data rule; and
using the level of similarity to determine whether to display that the existing data rule is similar to the proposed data rule.

9. The computing device of claim 8 wherein obtaining a list of entities that violate the proposed data rule comprises retrieving data for a collection of entities and applying the proposed data rule to the retrieved data.

10. The computing device of claim 9 wherein retrieving data for the collection of entities comprises retrieving data for a subset of entities in a system.

11. The computing device of claim 10 further comprising obtaining the list of entities that violate the existing rule by applying the existing rule to the data for the subset of entities in the system to identify the list of entities that violate the existing rule.

12. The computing device of claim 8 wherein determining a level of similarity between the list of entities that violate the proposed data rule and the list of entities that violate the existing data rule comprises forming a first vector for the list of entities that violate the proposed rule, forming a second vector for the list of entities that violate the existing data rule, and applying the first vector and the second vector to a function to generate a similarity score.

13. The computing device of claim 8 further comprising determining a respective level of similarity between the list of entities that violate the proposed data rule and each of a plurality of lists of entities that violate existing data rules.

14. The computing device of claim 13 further comprising using the levels of similarity between the list of entities that violate the proposed data rule and each of the plurality of lists of entities that violate existing data rules to determine which existing data rules to display as being similar to the proposed data rule.

15. A method comprising:
applying a new data rule against a subset of an entire data set to identify entities that violate the new data rule;
applying an existing data rule against the subset of the entire data set to identify entities that violate the existing data rule;
comparing the entities that violate the new data rule to the entities that violate the existing data rule; and
not applying the new data rule to the entire data set when the entities that violate the existing data rule are sufficiently similar to the entities that violate the new data rule.

16. The method of claim 15 wherein comparing entities that violate the new data rule to the entities that violate the existing data rule comprises constructing vectors and applying the vectors to a function.

17. The method of claim 15 further comprising:
for each existing data rule in a plurality of existing data rules:
applying the existing data rule against the subset of the entire data set to identify entities that violate the existing data rule; and
comparing the entities that violate the new data rule to the entities that violate the existing data rule; and
not applying the new data rule to the entire data set when the entities that violate one of the existing data rules in the plurality of existing data rules are sufficiently similar to the entities that violate the new data rule.

18. The method of claim 17 further comprising displaying an existing data rule when the entities that violate the existing data rule are sufficiently similar to the entities that violate the new data rule.

19. The method of claim 18 further comprising ordering existing data rules in the plurality of existing data rules based on a degree of similarity between the entities that violate each existing data rule and the entities that violate the new data rule.

20. The method of claim 19 further comprising displaying a plurality of existing data rules when the respective entities that violated each of the displayed existing data rules are sufficiently similar to the entities that violated the new data rule.
